(19) United States
(12) Patent Application Publication
(10) Pub. No.: US 2014/0167504 A1
(43) Pub. Date: Jun. 19, 2014

(54) PARALLEL BOOST VOLTAGE POWER SUPPLY WITH LOCAL ENERGY STORAGE

(71) Applicant: MICROSOFT CORPORATION, Redmond, WA (US)

(72) Inventors: Shaun L. Harris, Sammamish, WA (US); Brandon Aaron Rubenstein, Lynnwood, WA (US); Allan Joseph Wenzel, Bellevue, WA (US)

(73) Assignee: MICROSOFT CORPORATION, Redmond, WA (US)

(21) Appl. No.: 13/720,901

(22) Filed: Dec. 19, 2012

(51) Int. Cl. H02J 9/00

(52) U.S. Cl. CPC H02J 9/00
USPC 307/23

(57) ABSTRACT

A parallel boost voltage power supply with local energy storage comprises a local energy storage and a local energy storage boost converter that boosts the voltage of the local energy storage and provides it to existing DC bulk storage circuitry. Diodes in series with the boost converter and an existing power factor correction boost converter enable the DC bulk storage circuitry to receive power from both the local energy storage and external power sources. Transition between local energy storage and external power sources is performed in a controlled manner to avoid overloading external power sources. Additionally, local energy storage devices are recharged from an existing isolation transformer circuit in the power supply if the power being drawn from external sources is below a threshold. Operation without external power is extended via communications with server computing devices resulting in decreased power consumption by deactivating components or throttling down processors.

### BACKGROUND

The throughput of communications between multiple computing devices continues to increase. Modern networking hardware enables physically separate computing devices to communicate with one another orders of magnitude faster than was possible with prior generations of networking hardware. Furthermore, high-speed network communication capabilities are being made available to a greater number of people, both in the locations where people work, and in their homes. As a result, an increasing amount of data and services can be meaningfully provided via such network communications.

In particular, it has become more practical to perform digital data processing at a location remote from the location where such data is initially generated, and where the processed data will be consumed. For example, a user can upload a digital photograph to a server and then cause the server to process the digital photograph, changing its colors and applying other visual edits to it. In such an example, the digital processing, such as of the photograph, is being performed by a device that is remote from the user. Such remote digital processing can more advantageous than local processing for users who desire the greater processing capabilities than would be convenient for them to source locally, and for users who desire processing capabilities that are always available.

To provide such data and processing capabilities, via network communications, from a centralized location, the centralized location typically comprises hundreds or thousands of computing devices, typically mounted in vertically oriented racks. Such a collection of computing devices, as well as the associated hardware necessary to support such computing devices, and the physical structure that houses the computing devices and associated hardware, is traditionally referred to as a “data center”. With the increasing availability of high-speed network communication capabilities, and thus the increasing provision of data and services from centralized locations, as well as the traditional utilization of data centers, such as the provision of advanced computing services and massive amounts of computing processing capability, the size and quantity of datacenters continues to increase.

Additionally, data centers often consume large quantities of electrical power, especially by the computing devices themselves. In order to be able to provide uninterrupted processing capabilities, data centers often comprise one or more sources of backup power that can provide power to the data center, as a whole, should the primary source of power, such as electrical power from an electric utility grid, become temporarily unavailable. Typically, such backup power sources comprise electric generators, such as those powered by diesel fuel or natural gas. Thus, when the primary source of power becomes unavailable, the power supplies powering individual server computing devices temporarily operate off of a small battery backup that is external to the power supply. Once the backup source of power for the whole datacenter, such as the diesel electric generator, has become operational and sources the requisite voltage, the power supplies powering individual server computing devices detect the presence of such voltage and transition to drawing their electrical power from the electricity provided by such a generator.

Unfortunately, each power supply detects the presence of the voltage being provided by the generator at approximately the same time and seeks to transition to drawing electrical power from that generator at approximately the same time. Consequently, in a data center that consumes, for example, 2 MW of electricity, the generator will be asked to transition from providing almost no power at all to sourcing all 2 MW of electricity within a very short period of time, often on the order of a few milliseconds. Because generators often have a high output impedance, such a very large transient, in requiring the generator to so quickly source so much power, can cause a voltage droop. In many instances, the voltage droop can be sufficient to cause the power supplies to determine that electrical power is no longer being properly sourced and to again transition to operating off of an external battery backup. When the power supplies transition to operating off of an external battery backup, they can no longer consume electrical power being sourced by the generator, and, consequently, due to the sudden decrease in electrical load, the voltage being provided by the generator can return to its specified value. Once the voltage provided by the generator returns to its specified value, the power supplies can again detect the presence of such voltage and can again transition to drawing their electrical power from the generator, again resulting in a large transient, and again introducing the possibility that the voltage provided by the generator can droop. Such a cycle can be repeated multiple times, resulting in sub optimal operation, and potentially equipment damage.

### SUMMARY

In one embodiment, individual power supplies, such as for server computing devices, can comprise a local energy storage and a local energy storage boost converter that can enable the local energy storage to provide power while reusing existing power supply components. The local energy storage can comprise batteries and battery recharging and conditioning circuitry, or any other mechanism for storing and then subsequently providing electrical power. The local energy storage boost converter can comprise a transformer and a transistor-controlled circuit coupled to the transformer that can boost the voltage provided by the local energy storage such that the boosted voltage can be provided to existing DC bulk storage circuitry. Diodes in series with the local energy storage boost converter and an existing power factor correction boost converter can enable the DC bulk storage circuitry to receive power from both the local energy storage and external power sources.

In another embodiment, a local energy storage controller can transition between local energy storage and external power sources in a controlled manner to avoid overloading external power sources. Such a transition can be controlled by adjusting the duty cycle of an existing transistor-controlled circuit, which can be part of an existing power factor correction boost converter, such that external power sources provide only a limited amount of power during a transition period. The duty cycle of the transistor controlled circuit that can be part of the local energy storage boost converter can also be adjusted to control the amount of power being provided by local energy storage devices.

In a further embodiment, local energy storage devices can be recharged from an existing isolation transformer circuit that can be part of the power supply. The power being drawn from external power sources can be monitored and the recharging of local energy storage devices can be suspended if the power being drawn from external power sources is above a threshold. In such a manner, power supplies can avoid being sized with excess power supply capacity solely for the purpose of recharging local energy storage devices.

In a still further embodiment, local energy storage can provide power to one or more server computing devices for an extended period of time, such as if external power sources fail to operate properly, by communicating with one or more server computing devices. In response to indications from the power supply that the capacity of the local energy storage is dwindling, and that external power sources have not yet been made operational, one or more server computing devices can perform actions to decrease the amount of power consumed by such server computing devices including, for example, temporarily deactivating active cooling mechanisms that consume power, temporarily throttling down processing units, offloading one or more processing tasks to other server computing devices, and other like actions or combinations thereof.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Additional features and advantages will be made apparent from the following detailed description that proceeds with reference to the accompanying drawings.

### DESCRIPTION OF THE DRAWINGS

The following detailed description may be best understood when taken in conjunction with the accompanying drawings, of which:

FIG. 1 is a block diagram of exemplary existing data center power sources and the drawbacks thereof;

FIG. 2 is a block diagram of an exemplary parallel boost voltage power supply with local energy storage;

FIG. 3 is a circuit block diagram of a portion of an exemplary parallel boost voltage power supply with local energy storage;

FIG. 4 is a graph of an exemplary power transfer implemented by an exemplary parallel boost voltage power supply with local energy storage; and

FIG. 5 is a flow diagram of an exemplary operation of an exemplary parallel boost voltage power supply with local energy storage.

### DETAILED DESCRIPTION

The following descriptions are directed to a parallel boost voltage power supply with local energy storage that can be economically implemented due to a reutilization of existing power supply components, and which can provide advantages in transitioning between sources of external power. A parallel boost voltage power supply with local energy storage can comprise a local energy storage, such as in the form of batteries, or other power storage components, and a local energy storage boost converter that can enable the local energy storage to provide power while reusing existing power supply components. The local energy storage boost converter can comprise a transformer and a transistor-controlled circuit coupled to the transformer that can boost the voltage provided by the local energy storage such that the boosted voltage can be provided to existing DC bulk storage circuitry. Diodes in series with the local energy storage boost converter and an existing power factor correction boost converter can enable the DC bulk storage circuitry to receive power from both the local energy storage and external power sources. The parallel boost voltage power supply with local energy storage can transition between local energy storage and external power sources in a controlled manner to avoid overloading external power sources. Additionally, local energy storage devices can be recharged from an existing isolation transformer circuit that can be part of the power supply. The power being drawn from external power sources can be monitored and the recharging of local energy storage devices can be suspended if the power being drawn from external power sources is above a threshold. Should external power sources fail to operate properly, the parallel boost voltage power supply with local energy storage can provide power to one or more server computing devices for an extended period of time, such as by communicating with one or more server computing devices, in response to which those server computing devices can perform actions to decrease their power consumption, such as by temporarily deactivating active cooling mechanisms that consume power, temporarily throttling down processing units, offloading one or more processing tasks to other server computing devices, and other like actions or combinations thereof.

For purposes of illustration, the techniques described herein make reference to existing and known power supply circuitry such as AC-to-DC conversion circuitry, transistor controlled buck or boost circuitry, transformer circuitry and the like. References to specific circuits, circuit diagrams, and circuit components, however, are strictly exemplary and are not intended to limit the mechanisms described to the specific examples provided. Indeed, those of skill in the art will recognize that many alternative circuits exist that can accomplish the techniques and mechanisms described herein. Additionally, while the descriptions below will be provided within the context of server computing device power supplies, such as would be commonly utilized by server computing devices in a data center, they are not limited to such a use and, indeed, can be utilized to provide power to any electrical power-consuming device.

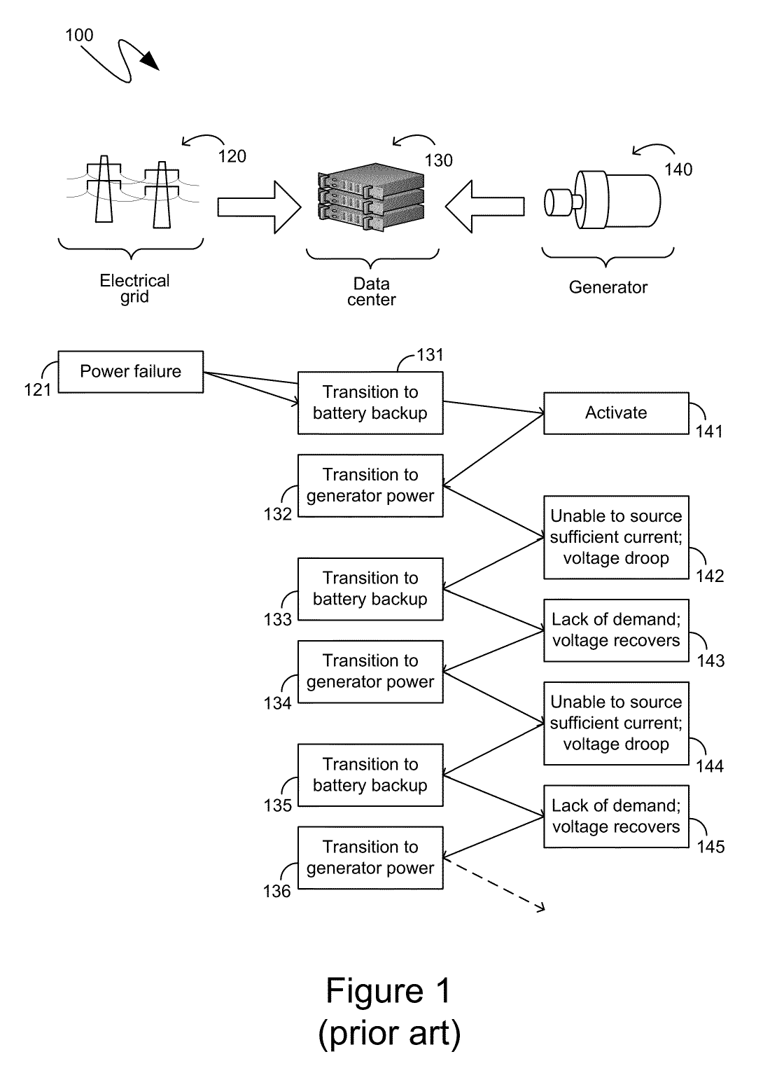

Turning to FIG. 1, the system 100 illustrated therein shows an exemplary existing system by which a data center, such as the data center 130, receives electrical power that is consumed by the processing units, computing devices, and other components of the data center 130. Typically, the data center 130 receives electrical power from an electrical grid 120, such as is typically provided by electrical utility companies. In alternative embodiments, however, a primary source of electrical power for the data center 130 can include natural gas or biogas fueled electrical power, solar or wind generated electrical power, and other like alternative forms of electrical power production. Nevertheless, irrespective of the mechanism utilized to provide primary electrical power to the data center 130, such electrical power cannot be made to be flawlessly reliable and, consequently, the data center 130 can typically comprise one or more backup sources of electrical power, such as a generator 140, that can provide electrical power to the data center 130 in instances where the primary source of electrical power, such as the electrical grid 120, fail.

A common scenario in the event of a failure in the primary source of electrical power is illustrated by the steps shown system 100 of FIG. 1. In particular, in the event of a power failure 121 in the electrical grid 120, the generator 140 can be activated at step 141, as illustrated by the causality arrows of FIG. 1. Simultaneously, individual power supplies of server computing devices of the data center 130 can transition, at step 131, to an external battery backup that can be provided for each server or collection of servers. As a result of the activation of the generator, at step 141, as, again, illustrated by the causality arrows of FIG. 1, individual power supplies of the server computing device of the data center 130 can detect the presence of the voltage being now provided by the generator 140, and can transition to generator power, as illustrated by step 132. As will be recognized by those skilled in the art, each individual power supply can detect the presence of the voltage being sourced by the generator 140 at approximately the same time and, consequently, each individual power supply will attempt to transition to generator power, as illustrated by step 132, at approximately the same time. If the data center 130 were to consume 2 MW of electricity, such as would be common for an average sized data center, then, because each of the individual power supplies can attempt to transition to generator power at approximately the same time, the generator 140 can be tasked with transitioning from supplying almost no electrical power to supplying 2 MW of electricity within a very short period of time, typically on the order of a few milliseconds. Such a large-scale transition to generator power, at step 132, can overwhelm the ability of the generator 140 to supply that much power in such short order and, consequently, at step 142, the voltage provided by the generator 140 can droop as the generator attempts to source all of the requested current.

In one common scenario, the voltage droop, at step 142, can be sufficiently large to trigger the individual power supplies of the server computing devices of the data center 130 to determine that external electrical power is no longer available, and to transition to an external battery backup, as illustrated by step 133. As will be recognized by those skilled in the art, as the individual power supplies of the server computing devices of the data center 130 transition to an external battery backup, at step 133, they can reduce the load on the generator 140 and, consequently, generator 140 can then provide the requisite voltage. Thus, as illustrated at step 143, the voltage provided by the generator 140 can recover due to the lack of demand as the power supplies transitioned to an external battery backup at step 133. In response to the voltage recovery at step 143, the power supplies can again detect the presence of such proper voltage, and can transition to generator power at step 134. The generator 140 can then, again, be unable to supply all of the requested power, as all of the power supplies attempted to transition to generator power, as illustrated at step 134. Thus, again, at step 144, the voltage provided by the generator 140 can droop due to the generator's inability to source a sufficient amount of current sufficiently quickly. The power supplies can then transition to an external battery backup, at step 135, due to the lack of a sufficient voltage level being provided by the external power source, namely the generator 140, and, once such demand is removed, the voltage can recover at step 145. Recovery of the voltage can then result in the power supplies transitioning to generator power at step 136, and such a cycle can continue to repeat itself, resulting in suboptimal performance, and possibly equipment damage and loss.

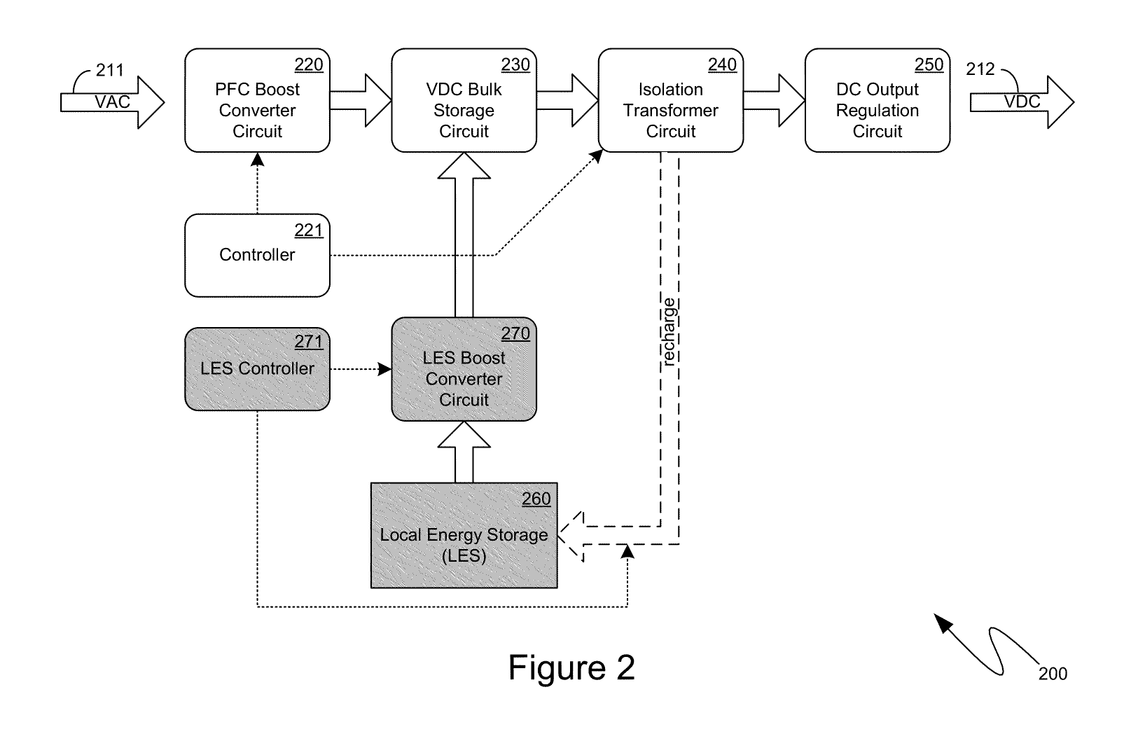

Turning to FIG. 2, the system 200 shown therein illustrates an exemplary parallel boost voltage power supply with local energy storage. Such a power supply can receive an input electrical power 211 in the form of alternating current electricity. Such input electrical power 211 can be directed to a power factor correction boost converter circuit 220, which can feed a direct current bulk storage circuit 230, that can, in turn, feed an isolation transformer circuit 240 from which a direct current output regulation circuit 250 can obtain direct current electrical energy 212 that can be output to the various electrical power consuming devices of, for example, a server computing device. Additionally, the power factor correction boost converter circuit 220, and the isolation transformer circuit 240 can be controlled by a controller 221. More specifically, and as will be recognized by those skilled in the art, controller 221 can control the power factor correction boost converter circuit 220 and the isolation transformer circuit 240 by controlling the duty cycle of one or more power switching transistors that are connected in series with inductors, in the case of the power factor correction boost converter circuit 220, or the windings of the isolation transformer in the case of the isolation transformer circuit 240. Thus, as utilized herein, the term “boost converter” means a circuit comprising at least one transistor and at least one inductive element and operated such that, through the alternative switching on and off of the at least one transistor, the output potential of such a circuit is greater than the input potential. Analogously, therefore, as utilized herein, the term “bulk storage” means a circuit comprising at least one capacitive element whose function is to provide power output stability, especially during transient events.

As will also be recognized by those skilled in the art, components 220, 230, 240, 250 and 221 are typically found in existing power supplies. Thus, in one embodiment, the components 220, 230, 240, 250 and 221 can be designed in the same manner as they would be for a traditional power supply. In an exemplary parallel boost voltage power supply with local energy storage, local energy storage 260 can be part of the power supply. The local energy storage 260 can comprise batteries, including batteries implemented in any chemical, electrical or mechanical form. Local energy storage 260 can, alternatively, or in addition, comprise other forms of electrical energy storage including, for example, capacitors or other like electrical energy storage devices. Additionally, the local energy storage 260 can also comprise recharging circuitry that can enable the electrical energy storage devices to replenish their electrical energy storage capacities. Local energy storage boost converter circuit 270 can operate to convert electrical energy provided with a lower voltage by the local energy storage 260 into electrical energy provided with a higher voltage which can then, in one embodiment, effect directly to an existing direct current bulk storage circuit 230. The local energy storage boost converter circuit 270 can be controlled by a local energy storage controller 271. Local energy storage controller 271 can operate in a manner analogous to that of the controller 221 insofar as local energy storage boost converter circuit 270 can be controlled by varying the duty cycle of one or more transistors. In one embodiment, the local energy storage controller 271 can comprise a separate controller unit from the controller 221.

In another embodiment, however, the controller 221 can comprise the functionality of the local energy storage controller 271 such that a single controller device is utilized to perform the functionality of both the controller 221 and the local energy storage controller 271. Either or both of the controllers 221 and 271 can be implemented as processing units, such as digital signal processors, or other like semiconductor-based devices.

In one embodiment, local energy storage boost converter circuit 270 can provide high-voltage direct current electrical energy to the direct current bulk storage circuit 230 and, in such a manner, a local energy storage can provide a temporary backup in the event of a loss of input electrical power 211 while utilizing the components of a traditional power supply, thereby reducing the cost of the implementation of the local energy storage and its attendant benefits. More specifically, power factor correction boost converter circuit 220 and the local energy storage boost converter circuit 270 can be coupled to the direct current bulk storage circuit 230 via a “diode OR” arrangement, wherein the power factor correction boost converter circuit 220 and the local energy storage boost converter circuit 270 are both, independently, coupled to the direct current bulk storage circuit 230 through one or more diodes that, when forward biased, will enable electrical power to flow to the direct current bulk storage circuit 230, and, when reversed biased, will prevent the flow of electrical power from one converter circuit into the other. While the descriptions provided herein reference diodes specifically, any one or more electrical components that have, either together or individually, an asymmetric transfer characteristic can equally be utilized. Thus, references to diodes made herein are equally intended to include any such one or more electrical components having an asymmetric transfer characteristic.

Additionally, in one embodiment, local energy storage 260 can be coupled to the isolation transformer circuit 240 such that the local energy storage 260 can be recharged via the isolation transformer circuit 240 while input electrical power 211 is present. The local energy storage controller 271 can, in one embodiment, monitor the input electrical power 211 and provide for the recharging of the local energy storage 260 when the input electrical power 211 is below a threshold amount. In such an embodiment, the parallel boost voltage power supply local energy storage can be sized more closely to the maximum power being consumed by the server computing device, without accounting for the power consumed when the local energy storage 260 is being recharged, because, in such an embodiment, the local energy storage 260 need not be recharged except when excess power supply capability exists.

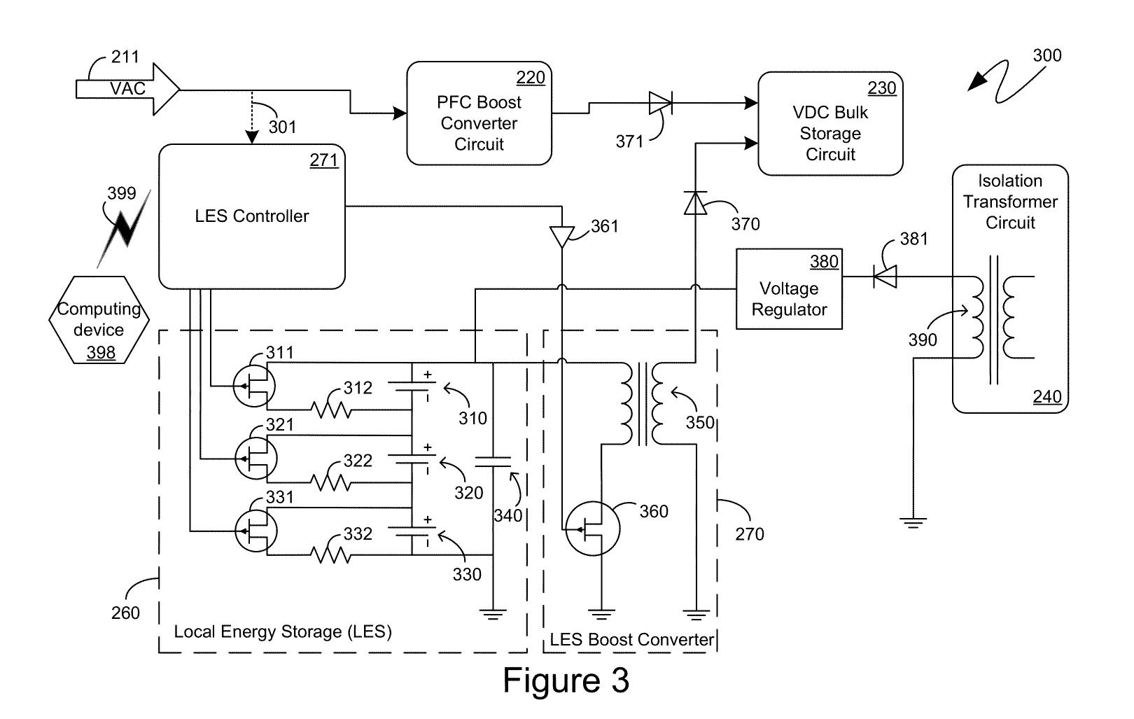

Turning to FIG. 3, the system 300 shown therein illustrates exemplary circuit implementation of the components described above. For example, as illustrated in the system 300 of FIG. 3, the local energy storage 260, which was described in detail above, is illustrated as comprising one or more batteries, such as the batteries 310, 320 and 330. In one embodiment, the batteries, or other energy storage devices, of the local energy storage 260 can be arranged in series such that the voltage produced by such energy storage devices is summed. Additionally, each of the batteries 310, 320 and 330 can comprise charging circuitry, which is illustrated in the exemplary system 300 of FIG. 3 as comprising a resistor to limit current flow and a transistor to variously activate and deactivate charging of the batteries. Thus, for example, the battery 310 can be coupled to a charging circuit that can comprise the transistor 311 and the resistor 312. The transistor 311 can control whether the battery 310 is charged by the power obtained from the isolation transformer circuit 240 via the voltage regulator 380, as will described in further detail below. In a similar manner, the battery 320 can be coupled to a charging circuit that can comprise the transistor 321 and the resistor 322, and the battery 330 can be coupled to a charging circuit that can comprise the transistor 331 and the resistor 332. The specific charging circuitry utilized can be dependent upon the types of batteries, or other energy storage devices, utilized by the local energy storage 260. Additionally, the control applied by the local energy storage controller 271, such as to the transistors 311, 321 and 331, can be in accordance with the type of recharging required by the specific batteries that are utilized. Additionally, each individual energy storage element, such as the individual batteries 310, 320 and 330, can be charged independently, such as through independent control of the transistors 311, 321 and 331. More specifically, in one embodiment, the local energy storage controller 271 can charge all of the batteries, such as the batteries 310, 320 and 330, at once and can monitor each individual battery. If one battery becomes full before the others have been fully recharged, the local energy storage controller 271 can cease recharging and can start discharging that one battery until its energy storage is equal to the to others. Recharging of all of the batteries can then resume.

The capabilities of the individual energy storage elements can be individually monitored by the local energy storage controller during discharge as well as during recharge. Consequently, in the event that a failure is detected in one of the individual energy storage elements, an appropriate notification can be generated, such as via a communicational connection 399 to one or more computing devices 398, including, for example, the one or more computing devices drawing power from the parallel boost voltage power supply with local energy storage. Such a notification can result in remedial measures being taken, such as replacing the failed battery, or replacing the entire power supply, prior to a subsequent power outage when such a failure could result in the power supply not functioning properly during a loss of external power. More specifically, and as will be known by those skilled in the art, a faulty battery may reach its minimum discharge voltage prior to the other batteries. In such a case, the local energy storage controller 271 can detect such a faulty battery and can, in one embodiment, provide the notifications described above and can further shut down the system to protect itself, if necessary.

In one embodiment, the local energy storage 260 can also comprise one or more capacitors, such as the capacitor 340, that can be positioned in parallel to the batteries, such as the batteries 310, 320 and 330, or other energy storage devices of the local energy storage 260. As will be recognized by those skilled in the art, a capacitor, such as the capacitor 340, can provide energy more quickly during periods of transient energy demand than can, for example, the batteries 310, 320 and 330.

If the input electrical power 211 were to deviate from acceptable levels, the power factor correction boost converter circuit 220 could no longer source a sufficient amount of voltage to keep the diode 371 forward biased and, consequently, the direct current bulk storage circuit 230 could no longer receive electrical power from the power factor correction boost converter circuit 220. In one embodiment, a controller, such as the local energy storage controller 271, can sense such a condition and can initiate operation of the local energy storage boost converter circuit 270. More specifically, the local energy storage controller 271 can cause the transistor 360 to switch on and off in either a fixed or variable duty cycle, thereby boosting the voltage sourced by the local energy storage 260, via the transformer 350, in a manner well known to those skilled in the art. For example, in one embodiment, the transistor 360 can be switched on and off using a 50% duty cycle for maximum efficiency. In other embodiments, other duty cycles can be utilized to accommodate the power requirements of the server computing device receiving power from the exemplary parallel boost voltage power supply with local energy storage. In the exemplary system 300 of FIG. 3, the transistor 360 is illustrated as being controlled by the local energy storage controller 271 via an amplifier 361, although, as will be recognized by those skilled in the art, other control circuitry can likewise be utilized.

With the local energy storage controller 271 activating the local energy storage boost converter circuit 270 in the manner described above, the voltage present at the output of the transformer 350, coupled with the lack of voltage being output by the power factor correction boost converter circuit 220, can cause the diode 370 to become forward biased enabling electrical power to flow from the local energy storage 260 to the direct-current bulk storage circuit 230 via the local energy storage boost converter circuit 270 and the now forward biased diode 370. In one embodiment, the components of the local energy storage boost converter circuit 270 can be selected based upon the voltage output by the local energy storage 260 and the voltage typically input into the direct-current bulk storage circuit 230. For example, the direct current bulk storage circuit 230 typically operates at approximately 380 volts, and if 10 lithium-ion batteries are utilized for the local energy storage 260, each outputting approximately 3.6 volts, then a transformer, such as the transformer 350 can be selected such that its windings result in an output voltage that is approximately 10 times greater than the input voltage.

Since the local energy storage boost converter circuit 270 can provide the direct current bulk storage circuit 230 with electrical power having an equivalent potential to that provided by the power factor correction boost converter circuit 220, the direct current bulk storage circuit 230, as well as other “downstream” components of the power supply, need not be modified to accommodate the receipt of power from the local energy storage 260. Consequently, the exemplary parallel boost voltage power supply with local energy storage can be implemented in an economical manner, as only the local energy storage 260, and local energy storage boost converter circuit 270, and, optionally, local energy storage controller 271, need be added to already existing power supply circuitry.

In one embodiment, the direct-current bulk storage circuit 230 can receive electrical power from either the power factor correction boost converter circuit 220, the local energy storage boost converter circuit 270, or combinations thereof. To provide protection against the back flow of current, diodes, such as the diodes 370 and 371, can be arranged in an “OR” configuration, with only one of the diodes 370 and 371 being forward biased and, thereby, allowing the flow of electrical energy through such a diode, at any particular point in time. Thus, for example, while the input electrical power 211 is present, the diode 371 can be forward biased and the diode 370 can be reverse biased. In such an arrangement, electrical power can flow through the diode 371 to the direct-current bulk storage circuit 230, but can be prevented, by the diode 370, from flowing backwards into the local energy storage boost converter circuit 270. Similarly, when the input electrical power 211 is temporarily not present, and a controller, such as the local energy storage controller 271, has enabled the local energy storage boost converter circuit 270 to provide electrical power to the direct current bulk storage circuit 230, the diode 370 can be forward biased, since the voltage from the local energy storage boost converter circuit 270 can be greater than any voltage seen on the other side of the diode 370, and, similarly, the diode 371 can become reverse biased and can, thereby, prevent the back flow of electrical power from the local energy storage boost converter circuit 270 into the power factor correction boost converter circuit 220.

A controller, such as the local energy storage controller 271, can monitor the input electrical power 211, as illustrated by the dashed line 301. Once the local energy storage controller 271 detects that an appropriate voltage is present at the input, it can transition from supplying power from the local energy storage 260 to consuming power from the input electrical power 211. In one embodiment, such a transition can occur incrementally over a defined period of time, thereby preventing overloading the source of the input electrical power 211, such as a generator. For example, when the local energy storage controller 271 detects an appropriate voltage present at the input, it can activate, or can instruct another controller to activate, the power factor correction boost converter circuit 220 such that at least a portion of the electrical power being provided by the exemplary parallel boost voltage power supply with local energy storage is sourced from the input electrical power 211. More specifically, one or more transistors in the power factor correction boost converter circuit 220 can be operated at a duty cycle such that less than 100% of the electrical power is sourced from the input electrical power 211. The remaining electrical power can be sourced from the local energy storage 260, with appropriate adjustments to the duty cycle of the transistor 360 of the local energy storage boost converter circuit 270. The amount of power sourced from the input electrical power 211 can continue to increase until the power factor correction boost converter circuit 220 is released to operate in a traditional manner where all of the power is sourced from the input electrical power 211. The local energy storage boost converter circuit 270 can then be deactivated such as, for example, by switching the transistor 360 into an off position.

Once power is again being entirely sourced from the input electrical power 211, the local energy storage controller 271 can look to recharge the local energy storage 260 to be prepared for a subsequent loss of the input electrical power 211. In one embodiment, the local energy storage 260 can be recharged from the same isolation transformer circuit 240 that can provide power to, for example, one or more server computing devices. For example, as illustrated in the system 300 of FIG. 3, a diode 381 can become forward biased when the voltage being provided by the local energy storage 260 is less than the voltage being obtained from the windings 390 in the isolation transformer circuit 240. In such an instance, electrical power to flow from the isolation transformer circuit 240 through the forward biased diode 381 into the voltage regulator 380 which can ensure a regulated voltage for the recharging of, for example, the batteries 310, 320 and 330 of the local energy storage 260. The recharging of such batteries can then be controlled by the local energy storage controller 271, via the transistors 311, 321 and 331, such as the manner described in detail above.

In one embodiment, the local energy storage controller 271 can monitor the input electrical power 211 and can deactivate the recharging of the local energy storage 260, such as by switching off the transistors 311, 321 and 331, if the input electrical power 211 exceeds a threshold amount. In such an embodiment, the exemplary parallel boost voltage power supply with local energy storage can be sized based upon the power consumption of the processing components, and other components, of the server computing device, and need not include any additional capacity for the recharging of backup sources of power, such as the local energy storage 260. If the server computing device is consuming the input electrical power 211 at an upper threshold amount, the local energy storage controller 271 can simply deactivate, or not enable, the recharging of the local energy storage 260, thereby leaving all of the input electrical power 211 for the server computing device. Conversely, if the server computing device is consuming the input electrical power of 211 below the upper threshold amount, there can exist additional power capacity which the local energy storage controller 271 can then utilize to recharge the local energy storage 260, should the local energy storage 260 need recharging, by, for example, activating the transistors 311, 321 and 331.

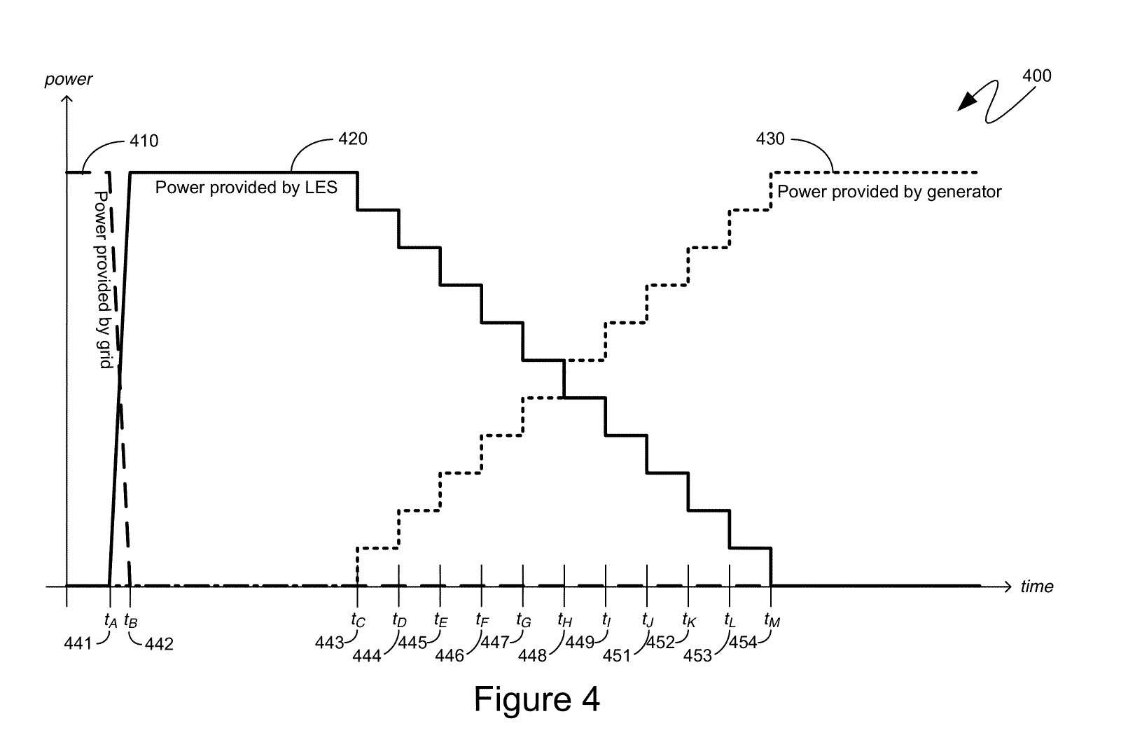

Turning to FIG. 4, the graph 400 shown therein illustrates an exemplary power graph illustrating an incremental transition to external electrical power from the local energy storage to avoid overloading one or more sources of the external electrical power. In the example illustrated by the graph 400, a grid electrical power 410, such as can be provided by a primary electrical power source, such as an electrical utility grid, can cease to be sourced at a time 441 and can become zero at a time 442 that can be very shortly thereafter, such as a few milliseconds after the time 441. In response, a local energy storage controller can activate a local energy storage boost converter circuit to generate local energy storage electrical power 420 from a local energy storage, such as in the manner described in detail above. The local energy storage electrical power 420 can be activated at the time 441 and can supply all of the power needs of, for example, a server computing device or other like device, by the time 442.

Subsequently, at a time 443, a controller associated with the local energy storage can detect the presence of voltage at the electrical power input indicating, for example, that a backup generator has been activated in response to the loss of the grid electrical power 410. Consequently, at the time 443, a controller can activate a power factor correction boost converter circuit such that a specified increment of generator electrical power 430 is consumed by the power supply from the time 443 until a subsequent time 444. Contemporaneously, between the time 443 and the time 444, a controller can also adjust the duty cycle of one or more transistors of a local energy storage boost converter circuit such that the local energy storage electrical power 420 that is provided by the local energy storage decreases by an appropriate amount. At the time 444 a similar process can repeat, with an incrementally greater amount of the generator electrical power 430 being consumed, again, by adjusting the duty cycle of one or more transistors in the power factor correction boost converter circuit, and an incrementally lesser amount of the local energy storage electrical power 420 being consumed. Such an incremental increasing of the consumption of the generator electrical power 430, and a corresponding incremental decreasing of the consumption of the local energy storage electrical power 420, can repeat at the times 445, 446, 447, 448, 449, 451, 452, 453 and 454, such as in the manner illustrated by the graph 400 of FIG. 4. At the time 454, the power supply can have transitioned to providing electrical power sourced by, for example, a generator, and the local energy storage no longer need provide any electrical power. By implementing a delay and staggering the amount of power consumed from, for example, the generator, such as in the manner illustrated by the graph 400, the generator can avoid being overloaded even if hundreds or thousands of individual power supplies each operate in the same manner and request additional power from the generator at approximately the same time. For example, the transition between the time 443 and the time 454 can be on the order of a few seconds or more, thereby avoiding transient power requests that a generator is not capable of handling. In one embodiment, the duration of time between the time 443 and the time 454 can be established based upon the type of generator or other sources of backup power, and their limitations with respect to being able to withstand large changes in the amount of electrical power requested and sourced. In one exemplary embodiment, the transition between the time 443 and the time 454 can be between 5 and 10 seconds. In another exemplary embodiment, the transition between the time 443 and the time 454 can be between 1 and 5 seconds. In yet another exemplary embodiment, the transition between the time 443 and the time 454 can be between 10 and 30 seconds.

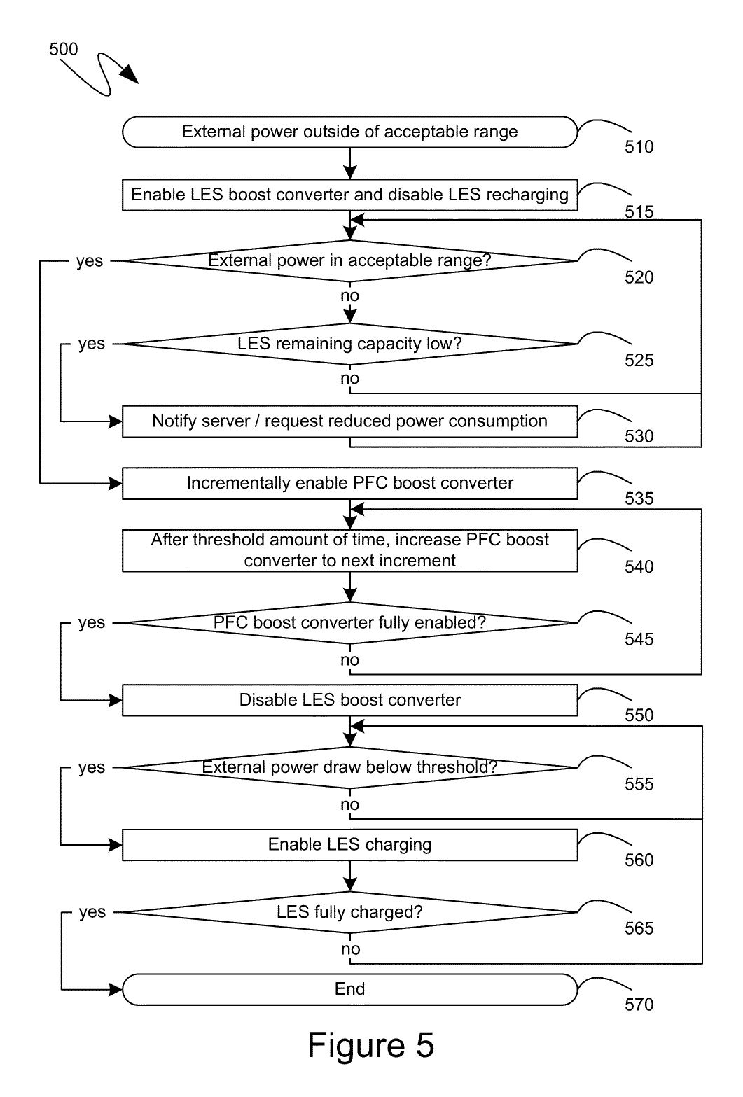

Turning to FIG. 5, the flow diagram 500 shown therein illustrates an exemplary series of steps that can be performed by one or more controllers of an exemplary parallel boost voltage power supply with local energy storage, such as that described in detail above. Initially, at step 510, the voltage of and external source of electrical power can be found to be outside of an acceptable range, including, for example, being either too high or too low. Subsequently, at step 515, a local energy storage boost converter can be enabled to provide power from local energy storage, and recharging of the local energy storage can be disabled. In one embodiment, such as if the external source of electrical power is found to have too high a voltage, at least some power can still be obtained from such an external source, and the local energy storage boost converter that can be enabled at step 515 can only provide additional power to “make up” the difference. At step 520, a determination can be made as to whether the external electrical power has been reestablished. As indicated previously, such a determination can be made based upon a sensing communicational coupling between the external electrical power input and one or more controllers of a power supply. Consequently, while indicated as an explicit step at step 520, such a determination can be continuously evaluated.

If, at step 520, external power has been reestablished, then processing can proceed to step 535, which is described in further detail below. Conversely, if, at step 520, external power has not yet been reestablished, processing can proceed to step 525, where a determination as to whether the remaining capacity of the local energy storage to provide electrical power has fallen below a threshold. If, at step 525, it is determined that the remaining capacity of the local energy storage has not yet fallen below a threshold, then processing can loop back to step 520, as illustrated. Conversely, if, at step 525, it is determined that the remaining capacity of the local energy storage has fallen below a threshold, then processing can proceed to step 530 and a server computing device, such as the server computing device consuming the power, can be notified or can be explicitly requested to reduce power consumption so that the local energy storage can continue to power the server computing device for long as possible while one or more sources of external backup power are brought online. For example, a server computing device can temporarily deactivate electrical energy consuming cooling apparatuses, such as fans, in order to reduce the consumption of electrical power, because, for temporary periods of time, server computing devices can operate their processing units at higher temperatures then would be desirable for long-term operation. As another example, a server computing device can temporarily throttle down its processors or otherwise decrease their ability to perform processing or reduce the amount of processing they perform such as, for example, by offloading processes to one or more other server computing devices, such as server computing devices in datacenters not affected by power outages. Once the notification or request has been transmitted at step 530, processing can return to step 520. Additionally, as with step 520, step 525 can be based on a sensing communicational coupling that can be continuously evaluated, rather than being an explicit step as illustrated.

Returning back to step 520, if it is determined that external power has been reestablished, processing can proceed with step 535 in which, in one embodiment, the power factor correction boost converter circuit can be enabled incrementally such that the power being consumed from external power is below an incremental threshold, with the remainder still being sourced from the local energy storage, such as in the manner described in detail above. Subsequently, at step 540, after a threshold amount of time, the power factor correction boost converter circuit can be further enabled such that the power being consumed from external power is below a subsequent incremental threshold that is greater than the incremental threshold established at step 535. At step 545, a determination can be made as to whether all of the power being consumed is being sourced by the external power source. If, at step 545, it is determined that only a portion of the power being consumed is being sourced externally, processing can return back to step 540 and, after a further amount of time, the power being consumed from external power can be increased such that it is less than a still further incremental threshold. Consequently, processing can proceed, such as in the manner described in detail above, until, at step 545, it is determined that the power factor correction boost converter has been fully enabled and the power is wholly being sourced from the external power source. In such an instance, processing can proceed to step 550, as illustrated in FIG. 5, and the local energy storage boost converter circuit can be disabled, thereby ceasing the sourcing of electrical power from the local energy storage.

At step 555, once all of the power being consumed is being sourced by the external power source, a determination can be made as to whether the power being consumed is below a threshold for the power supply. If, at step 555, it is determined that the power being consumed is above such a threshold, processing can return back to step 555. Once the power being consumed falls below the threshold, processing can proceed to step 560, and recharging of the local energy storage can be initiated. Subsequently, at step 565, a determination can be made as to whether the local energy storage has become fully charged. If the local energy storage is not yet fully charged, as determined at step 565, processing can return to step 555, described above. Conversely, if, at step 565, it is determined that the local energy storage is fully charged, then the relevant processing can end at step 570.

As can be seen from the above description, a parallel boost voltage power supply with local energy storage has been presented. In view of the many possible variations of the subject matter described herein, we claim as our invention all such embodiments as may come within the scope of the following claims and equivalents thereto.

We claim:

1. A power supply comprising:
output circuitry supplying power to one or more devices that are coupled to the power supply;
one or more energy storage devices;
a power factor correction boost converter circuit coupled to the output circuitry and to one or more power sources external to the power supply; the power factor correction boost converter circuit being configured to transfer power from the one or more external power sources to the output circuitry;
a local energy storage boost converter circuit coupled to the output circuitry and to the one or more energy storage devices; the local energy storage boost converter circuit being configured to transfer power from the one or more energy storage devices to the output circuitry at an equivalent potential to that utilized by the power factor correction boost converter circuit;
a first electrical component having an asymmetric transfer characteristic, the first electrical component positioned between the local energy storage boost converter circuit and the output circuitry, the first electrical component being oriented to enable power flow from the local energy storage boost converter circuit to the output circuitry and to prevent power flow from the power factor correction boost converter circuit back into the local energy storage boost converter circuit; and
a second electrical component having an asymmetric transfer characteristic, the second electrical component positioned between the power factor correction boost converter circuit and the output circuitry, the second electrical component being oriented to enable power flow from the power factor correction boost converter circuit to the output circuitry and to prevent power flow from the local energy storage boost converter circuit back into the power factor correction boost converter circuit.

2. The power supply of claim 1, further comprising a controller configured to activate the local energy storage boost converter circuit if the one or more power sources external to the power supply are no longer providing power to the power supply.

3. The power supply of claim 2, wherein the controller controls the local energy storage boost converter circuit utilizing a fixed duty cycle for one or more transistors of the local energy storage boost converter circuit.

4. The power supply of claim 2, wherein the controller controls the local energy storage boost converter circuit utilizing a variable duty cycle for one or more transistors of the local energy storage boost converter circuit.

5. The power supply of claim 2, wherein the controller is further configured to deactivate the local energy storage boost converter circuit if the one or more power sources external to the power supply can again provide power to the power supply.

6. The power supply of claim 2, wherein the controller is further configured to perform steps comprising:
determining that the one or more power sources external to the power supply can again provide power to the power supply;
activating, in response to the determining, the power factor correction boost converter circuit such that less than a first threshold amount of power is obtained from the one or more power sources external to the power supply, the first threshold amount of power being less than an amount of power being provided by the power supply;
incrementing, after a delay since the activating, the power factor correction boost converter circuit such that greater than the first threshold amount of power, but less than a second threshold amount of power, is obtained from the one or more power sources external to the power supply, the second threshold amount of power being greater than the first threshold amount of power, but still being less than an amount of power being provided by the power supply; and
repeating the incrementing until the power being provided by the power supply is being obtained from the one or more power sources external to the power supply.

7. The power supply of claim 6, wherein the delay is such that a few seconds elapse between the activating the power factor correction boost converter circuit and a stopping of the repeating the incrementing.

8. The power supply of claim 2, wherein the controller is communicationally coupled to a computing device drawing power from the power supply.

9. The power supply of claim 1, wherein the local energy storage boost converter circuit transfers electrical power to the output circuitry at approximately 380 volts.

10. The power supply of claim 1, further comprising a recharging circuit for recharging the one or more energy storage device, the recharging circuit comprising windings on an isolation transformer that is part of the output circuitry.

11. The power supply of claim 1, wherein the one or more energy storage devices comprise batteries connected in series.

12. The power supply of claim 1, wherein a recharging of each of the one or more energy storage devices is controlled independently.

13. A method of transitioning between obtaining power from external power sources and obtaining power from local energy storage devices, the method comprising the steps of:
detecting a loss of power from the external power sources;
activating a local energy storage boost converter circuit to provide power from the local energy storage devices to power output circuitry at an equivalent potential to that with which the power output circuitry received power that was sourced from the external power sources.

14. The method of claim 13, further comprising the steps of:
determining that the external power sources can again provide power;
activating, in response to the determining, a power factor correction boost converter circuit such that less than a first threshold amount of power is obtained from the external power sources, the power factor correction boost converter circuit providing, to the power output circuitry, the power sourced from the external power sources;
incrementing, after a delay since the activating, the power factor correction boost converter circuit such that greater than the first threshold amount of power, but less than a second threshold amount of power, is obtained from the external power sources; and
repeating the incrementing until a transition from an obtaining of power from local energy storage devices to an obtaining of power from the external power sources is complete.

15. The method of claim 13, further comprising the steps of: notifying a computing device consuming the obtained power that the local energy storage devices are becoming depleted of energy and that the external power sources are not yet capable of providing power.

16. The method of claim 13 further comprising the steps of: notifying a computing device consuming the obtained power of a detected failure of one the local energy storage devices prior to the loss of power from the external power sources.

17. A controller device configured to perform steps comprising:
detecting a loss of power from external power sources;
activating a local energy storage boost converter circuit to provide power from the local energy storage devices to power output circuitry of a power supply at an equivalent potential to that with which the power output circuitry received power that was sourced from the external power sources.

18. The controller device of claim 17, being further configured to perform steps comprising:
determining that the external power sources can again provide power;
activating, in response to the determining, a power factor correction boost converter circuit such that less than a first threshold amount of power is obtained from the external power sources, the power factor correction boost converter circuit providing, to the power output circuitry, the power sourced from the external power sources;
incrementing, after a delay since the activating, the power factor correction boost converter circuit such that greater than the first threshold amount of power, but less than a second threshold amount of power, is obtained from the external power sources; and
repeating the incrementing until a transition from an obtaining of power from local energy storage devices to an obtaining of power from the external power sources is complete.

19. The controller device of claim 17, being further configured to perform steps comprising: notifying a computing device consuming the obtained power that the local energy storage devices are becoming depleted of energy and that the external power sources are not yet capable of providing power.

20. The controller device of claim 17, being further configured to perform steps comprising: notifying a computing device consuming the obtained power of a detected failure of one the local energy storage devices prior to the loss of power from the external power sources.
